(19) United States
(12) Patent Application Publication
(10) Pub. No.: US 2026/0037286 A1
(43) Pub. Date: Feb. 5, 2026

(54) Adding Voice or Chat User interface to graphical user interface (gui)-based virtualized applications and desktops using large language and large action models

(71) Applicant: Citrix Systems, Inc., Fort Lauderdale, FL (US)

(72) Inventors: Hubert Divoux, Parkland, FL (US); Mukund Ingale, Pompano Beach, FL (US)

(21) Appl. No.: 18/791,986

(22) Filed: Aug. 1, 2024

(51) Int. Cl. G06F 9/451; G06F 9/48; G06F 40/279; H04L 9/40

(52) U.S. Cl. CPC G06F 9/452; G06F 9/4881; G06F 40/279; H04L 63/083

(57) ABSTRACT

Methods and systems for enhanced remote desktop interfaces are described. A computing system may train, using historical or live information, a LAM to execute, within a remote desktop application, textual actions with their parameters if any. A user declarative request (voice or chat) may be interpreted by a LLM to match a specific action (and potentially ask for the corresponding parameters in a conversational way). Subsequently, from the textual action and its parameters, the LAM may execute the action within a remote desktop application and report the result to the user via voice or chat.

### FIELD

Aspects described herein generally relate to computer networking, remote computer access, virtualization, enterprise mobility management, recent developments in the artificial intelligence (AI) landscape (e.g., large language models (LLM), large action models (LAM), or the like), and hardware and software related thereto. More specifically, one or more aspects described herein include adding a voice and/or chat user interface to existing graphical user interface (GUI)-based virtualized applications and desktops.

### BACKGROUND

In some instances, virtualization systems for desktops and/or applications aim to provide end-users with the same or near identical experiences as if the desktops/applications were being used locally. For GUI-based desktops and applications, a suitable end-user experience may be achievable if the client device has a display that is reasonably sized (e.g., a laptop, tablet, or the like). This may become challenging, however, if the client device display is small (e.g., a smart phone), or impossible if the client device has no display or the end-user is not able to (or does not want to) look at the device screen (e.g., using a hand-free system while driving a car).

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards adding a voice or chat user interface to graphical user interface (GUI) based virtualized applications and desktops using large language and large action models.

A computing system including one or more processors, a communication interface, and memory, storing one or more instructions that, when executed by the one or more processors, cause the computing system to train, using historical remote desktop interaction information indicating user inputs and corresponding actions executed within historical remote desktop application sessions, a large action model (LAM), which may configure the LAM to execute, for a given textual input, one or more actions to perform within a given remote desktop application to complete a task requested by the given textual input. The computing system may deploy, to a remote desktop host server, a LAM agent, configured to access the LAM to identify the one or more actions. The computing system may receive, during a remote desktop session, a textual input indicating a first task to perform. The computing system may identify, based on the first task, a remote desktop application configured to perform the task and a list of actions that the remote desktop application is configured to perform. The computing system may identify, using a large language model (LLM), at least one action of the list of actions to execute to perform the task. The computing system may execute, using the LAM, the at least one action to produce an action result. The computing system may display the action result, which may be an indication that the task has been executed.

In one or more instances, training the LAM may be further based on lists of actions corresponding to each remote desktop application of a plurality of remote desktop applications, where each list of actions may be labelled based on the corresponding remote desktop application. In one or more instances, the computing system may establish, based on successful validation of authentication credentials provided at a client device, the remote desktop session, where establishing the remote desktop session may include receiving, at the client device and from the remote desktop host server, an authentication token.

In one or more examples, establishing the remote desktop session may include identifying one or more applications corresponding to the remote desktop session and, for each of the one or more applications, a list of actions that the corresponding application is configured to perform. In one or more examples, the computing system may identify the remote desktop application by applying a large language model to the textual input to identify the remote desktop application.

In one or more instances, the computing system may launch, after identifying the remote desktop application, before identifying the at least one action, and via communication with the remote desktop host server, the remote desktop application. In one or more instances, after launching the remote desktop application and prior to the identification of the at least one action, the computing system may establish a connection between a client device and the remote desktop host server.

In one or more examples, the connection may be a remote desktop protocol connection, a websocket connection, or a LAM virtual channel (VC).

In one or more examples, the computing system may collect feedback on the action result, and update, based on the feedback, the LAM agent. In one or more examples, the client device comprises one of: smart glasses or a mobile device

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5B depict an illustrative computing environment for adding a voice or chat user interface to graphical user interface (GUI) based virtualized applications and desktops using large language and large action models in accordance with one or more illustrative aspects described herein.

FIGS. 6A-6C depict an illustrative event sequence for adding a voice or chat user interface to graphical user interface (GUI) based virtualized applications and desktops using large language and large action models in accordance with one or more illustrative aspects described herein.

FIGS. 7-9 depict an illustrative methods for adding a voice or chat user interface to graphical user interface (GUI) based virtualized applications and desktops using large language and large action models in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards adding a voice or chat user interface (UI) to graphical user interface (GUI) based virtualized applications and desktops using large language and large action models. The voice UI (VUI) and chat UI (CUI) may both accept high level declarative style requests in a conversational way. Virtualized applications and desktops may become usable with a range of new emerging devices, including devices only providing voice user interfaces. This may be a no code solution.

Virtualized/published desktops and/or application enumeration data may be sent to a remote desktop client application (e.g., running on a client device) that hosts the VUI, CUI, or the like, including a list of actions (and associated parameters) that may be executed by a large action mode (LAM) agent with each application or desktop. These chat/voice UIs may use a large language model (LLM) to deduce which action the end-user is requesting in a conversational way, and may retrieve the parameters of the actions. Based on these parameters, a desktop or application may be selected for use in executing the requested action. This may include the introduction of a LAM virtual channel and a lightweight remote desktop protocol for use with chat/voice UIs in remote desktop applications.

More specifically, foundational elements of this system may include: 1) a virtualization system for desktops/applications with a remoting display protocol (which may e.g., be an adaptation of an existing virtualization system), 2) a large language model (LLM) such as ChatGPT, and 3) a large action model (LAM). The remote desktop client application VUIs and/or CUIs may both accept high level declarative style requests in a conversational way. This may be different from the typical imperative and detailed style commands (which may be voice commands), which may, for example, be used by taking advantage of standards like Section 508 or the Web Content Accessibility Guidelines, or even UI automation tools.

This system may be a no-code solution that is applicable to any published desktops or applications without the need to write any code (e.g., to interact with an application programming interface (API)). Generally, this solution may facilitate an increase in usage scenarios of a virtualization system by adding a voice and/or chat user interface to existing and/or legacy GUI based virtualized applications and desktops. In some instances, the client device form factor may be smaller than a typical smartphone, and might not necessarily include a display (e.g., smart glasses, or the like). Alternatively, the client device may also be a more standard device (e.g., smart phone, tablet, laptop, or the like), as long as it can provide the functionality needed for VUI and/or CUI.

This solution may also enhance existing/legacy GUI-based virtualization applications or desktops by giving the ability to the end-user to issue high level declarative style requests via an additional VUI and/or CUI and subsequently observe/use the results. This may be in contrast to using a standard GUI and associated traditional input methods, which may be imperative by definition (e.g., mouse point and click, keyboard inputs, or the like).

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

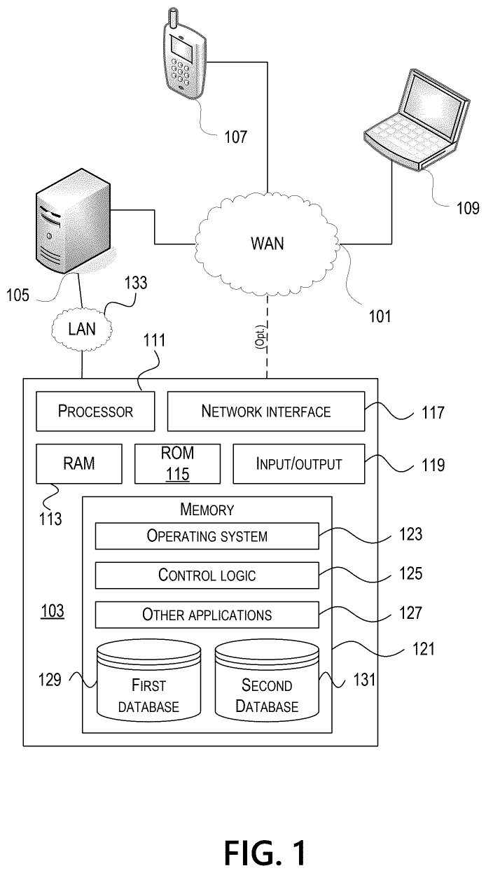

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

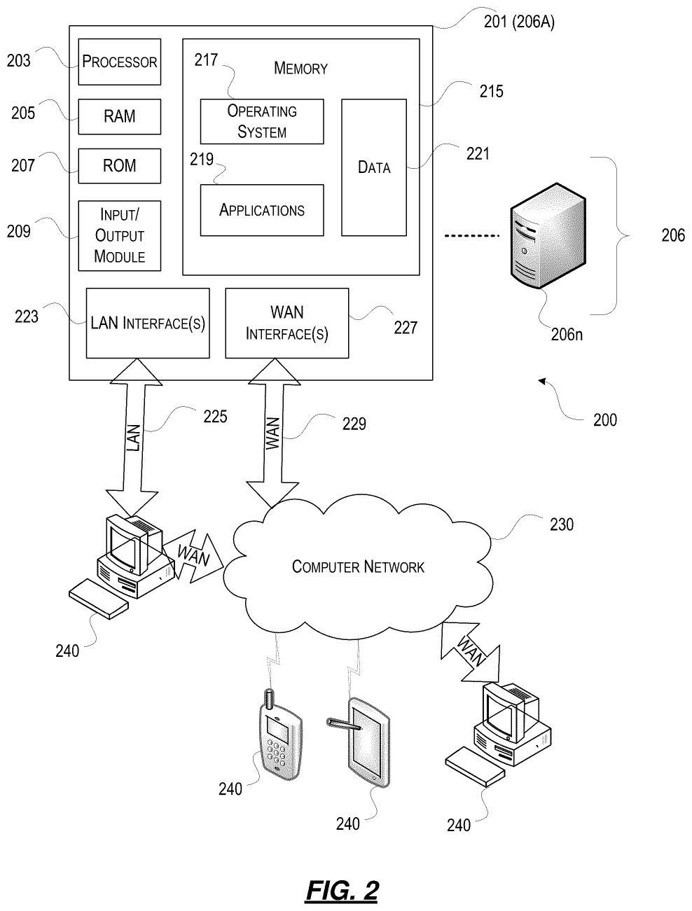

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

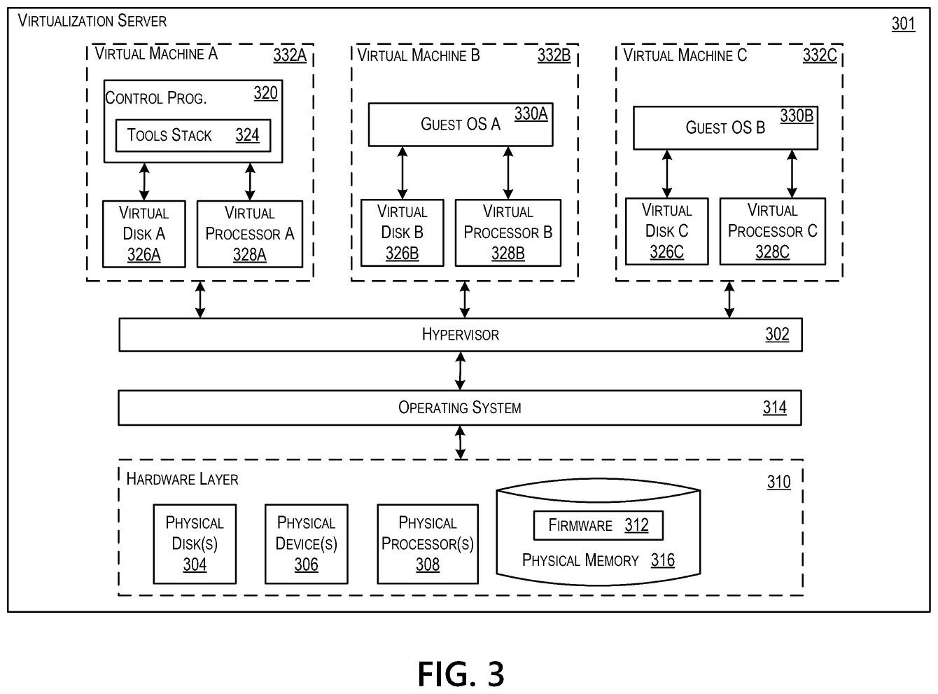

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

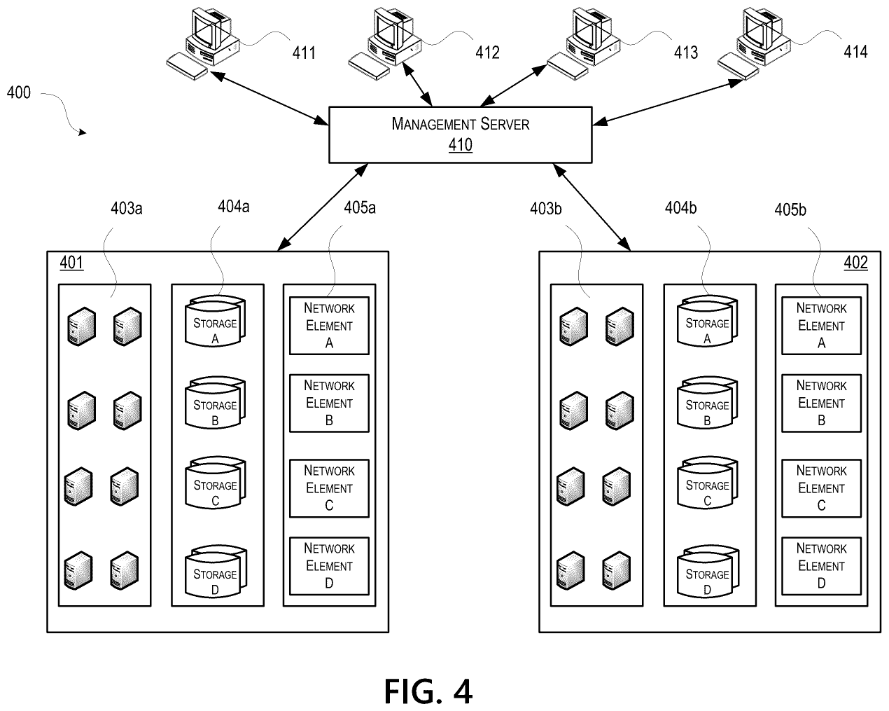

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Adding Voice or Chat User Interface to Graphical User Interface (GUI)-Based Virtualized Applications and Desktops Using Large Language and Large Action Models

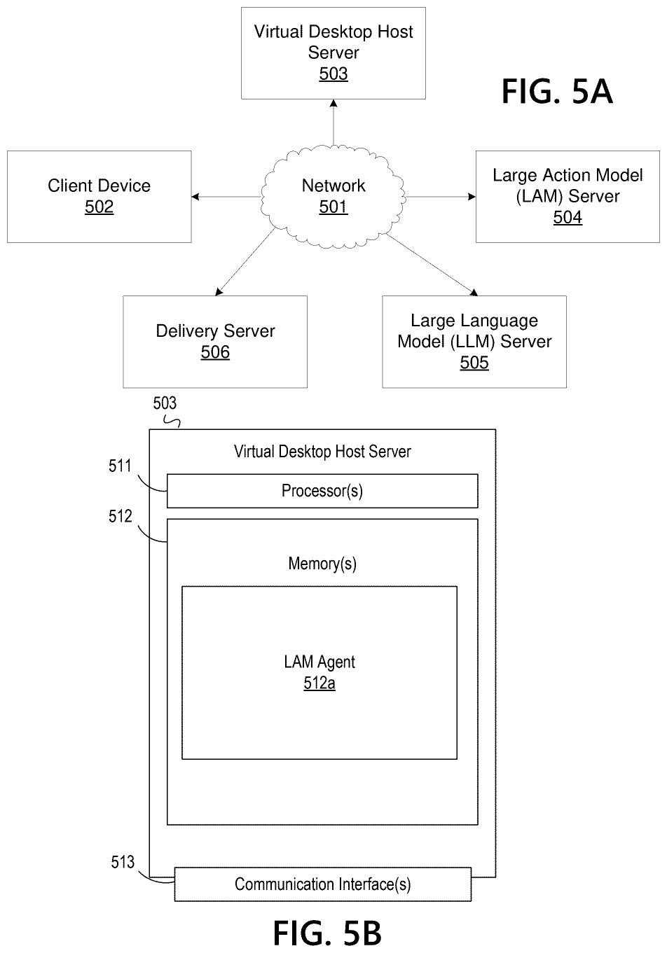

FIGS. 5A-5B depict an illustrative computing environment for training and deploying a large action model to facilitate voice and/or chat interfaces in GUI based virtualized applications and desktops in accordance with one or more example embodiments. Referring to FIG. 5A, computing environment may include one or more computer systems. For example, the computing environment may include a client device 502, virtual desktop host server 503, large action model (LAM) server 504, large language model (LLM) server 505, delivery server 506.

As illustrated in greater detail below, client device 502 may be a personal computing device such as a smartphone, tablet, laptop computer, desktop computer, smart glasses, smart watch, or the like. In some instances, client device 502 may be configured to facilitate the performance of tasks through one or more virtual desktops or virtual applications. In some instances, the client device 502 may be configured to display graphical user interfaces, which may include chat interfaces, or the like. Additionally or alternatively, the client device 502 might not be configured to display user interfaces, and may instead receive commands via a voice input interface. Although a single client device is depicted, any number of such devices may be implemented in the methods described herein without departing from the scope of the disclosure.

Virtual desktop host server 503 may be a computer system that includes one or more computing devices (e.g., servers, server blades, or the like) and/or other computer components (e.g., processors, memories, communication interfaces). In one or more instances, virtual desktop host server 503 may be configured to support the application and processing of one or more virtual desktops, applications, or the like. In some instances, the virtual desktop host server 503 may be configured with a LAM agent, configured to collaborate with the LAM server 504 to identify particular actions to perform, and to execute the actions accordingly.

LAM server 504 may include one or more servers or the like configured for to train a LAM and/or the LAM agent. For example, the LAM may include a database of LAM training data, a list of applications performed by various desktops/applications, and/or other information. In some instances, this LAM database may be hosted by another computing system. The LAM server 504 may be configured to communicate with the virtual desktop host server 503 (and/or the LAM agent) to execute various actions.

LLM server 505 may include one or more servers, or the like, configured to train, support, and/or otherwise deploy a LLM to identify, from text and/or voice based conversational requests and a list of possible actions to perform in response to the requests, a relevant action and the corresponding virtual desktop and/or application to launch. In some instances, the LLM server 505 may be separate from the LAM server 504 and/or the virtual desktop host server 503. In other instances, a single server may perform the functions of the virtual desktop host server 503, LAM server 504, and/or LLM server 505.

Delivery server 506 may include one or more servers, or the like, configured as a web server (supporting both user interfaces and application programming interfaces) and a cloud broker. For example, the delivery server 506 may support authentication of a remote desktop client application from the client device to obtain enumeration of virtual desktops and/or applications. In some instances, delivery server 506 may support the launch of one or more virtual desktops and/or applications via an associated UI, CUI, VUI, or the like. In these instances, the delivery server may provide the UI, CUI, VUI, or the like to the remote desktop client application (which may include a web browser) locally, via a web interface, and/or otherwise.

Computing environment 400 may also include one or more networks, which may interconnect client device 502, virtual desktop host server 503, LAM server 504, LLM server 505, and delivery server 506. For example, computing environment 400 may include a wired or wireless network 501 (which may e.g., client device 502, virtual desktop host server 503, LAM server 504, LLM server 505, and delivery server 506).

In one or more arrangements, client device 502, virtual desktop host server 503, LAM server 504, LLM server 505, delivery server 506, and/or the other systems included in the computing environment may be any type of computing device capable of receiving a text and/or voice based interface, receiving input via the interface, and communicating the received input to one or more other computing devices. For example, client device 502, virtual desktop host server 503, LAM server 504, LLM server 505, delivery server 506, and/or the other systems included in the computing environment may in some instances, be and/or include server computers, desktop computers, laptop computers, tablet computers, smart phones, smart watches, smart glasses, or the like that may include one or more processors, memories, communication interfaces, storage devices, and/or other components. As noted above, and as illustrated in greater detail below, any and/or all of client device 502, virtual desktop host server 503, LAM server 504, LLM server 505, and delivery server 506 may, in some instances, be special purpose computing devices configured to perform specific functions.

Referring to FIG. 5B, virtual desktop host server 503 may include one or more processors 511, memory 512, and communication interface 513. A data bus may interconnect processor 511, memory 512, and communication interface 513. Communication interface 513 may be a network interface configured to support communication between the virtual desktop host server 503 and one or more networks (e.g., network 501, or the like). Memory 512 may include one or more program modules having instructions that when executed by processor 511 cause virtual desktop host server 503 to perform one or more functions described herein and/or access one or more databases that may store and/or otherwise maintain information which may be used by such program modules and/or processor 511. In some instances, the one or more program modules and/or databases may be stored by and/or maintained in different memory units of virtual desktop host server 503 and/or by different computing devices that may form and/or otherwise make up virtual desktop host server 503. For example, memory 512 may have, host, store, and/or include a LAM agent 512a that may cause the virtual desktop host server 503 to facilitate selection and execution of actions based on received requests.

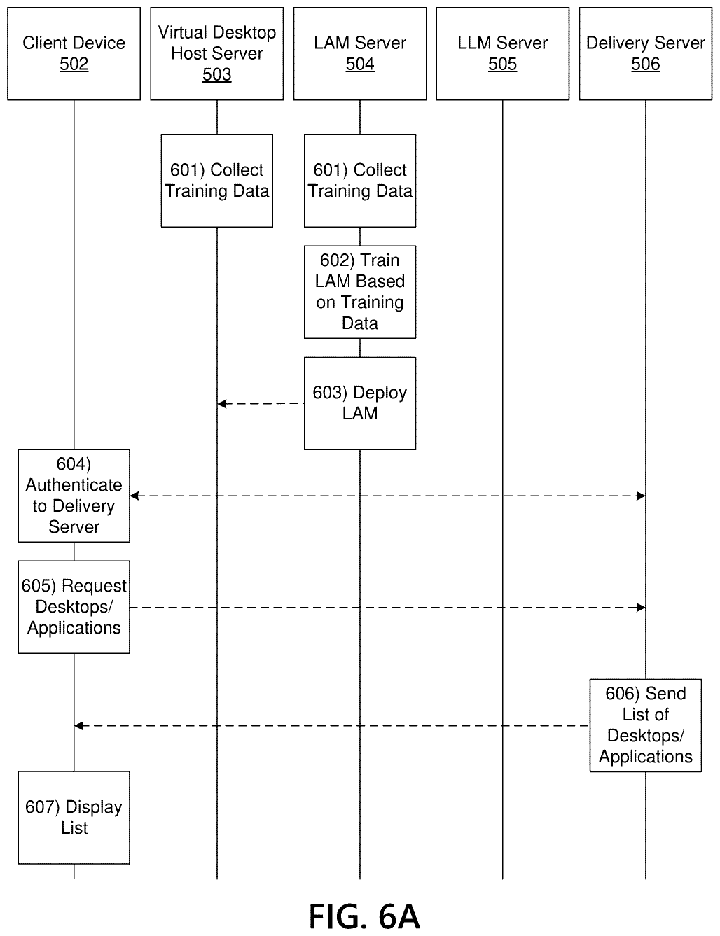

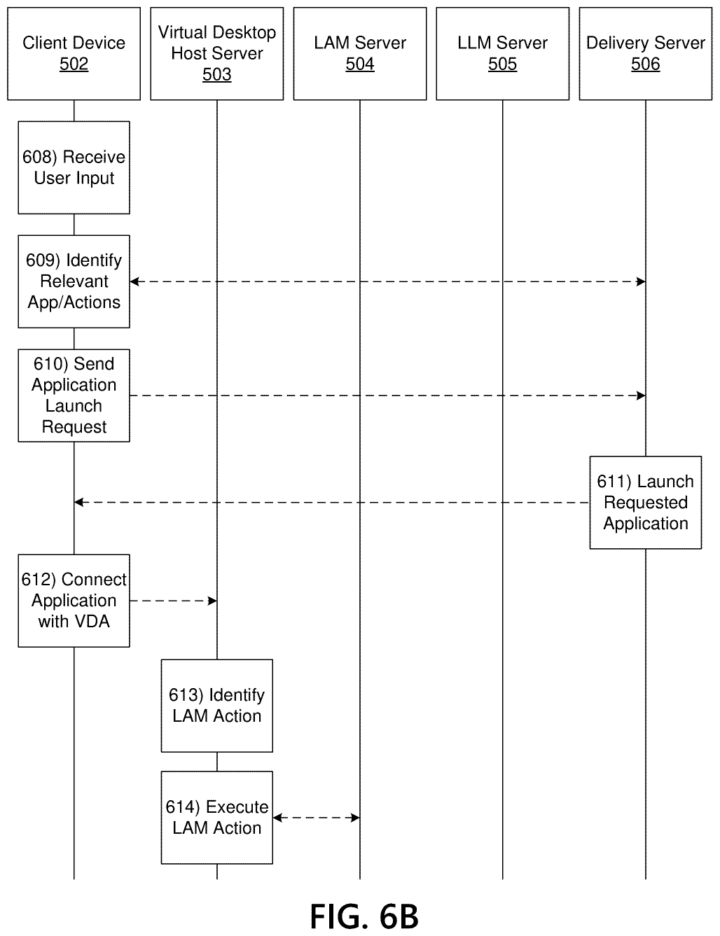

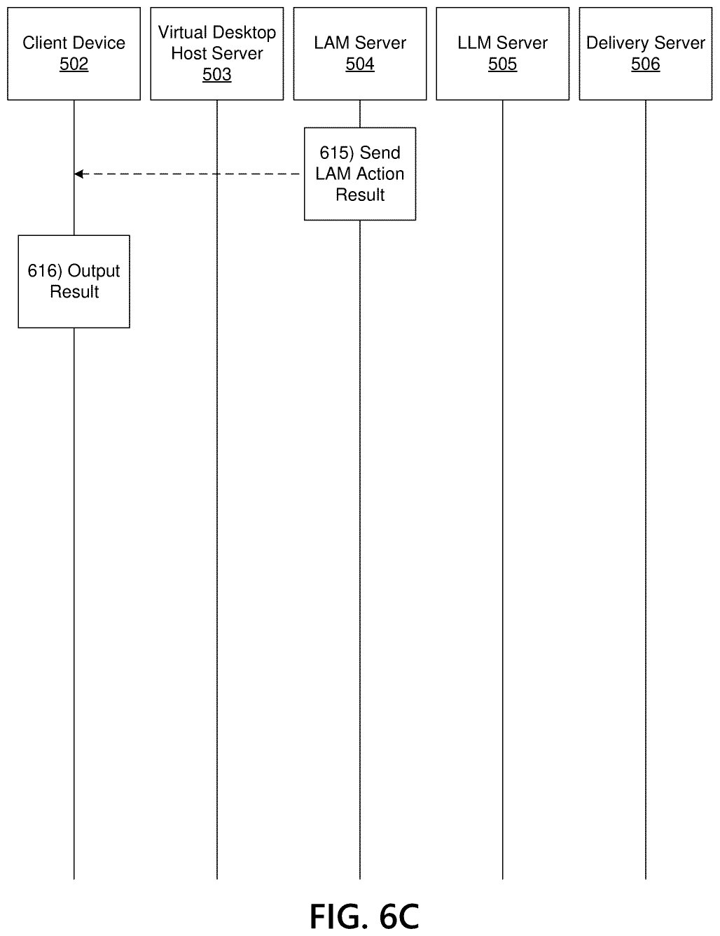

FIGS. 6A-6C depict an illustrative event sequence for training and deploying a large action model to facilitate voice and/or chat interfaces in GUI based virtualized applications and desktops in accordance with one or more example embodiments. It should be understood that steps 601-616 may, in some instances, occur in the order as shown with regard to FIGS. 6A-6C. For example, after completing step 607 of FIG. 6A, the event sequence may proceed to step 608 of FIG. 6B.

Referring to FIG. 6A, at step 601, the LAM server 504 and/or virtual desktop host server 503 may collect training data for the LAM. For example, the LAM server 504 may collect training data. For example, during a plurality of remote desktop and/or application sessions, as end users are interacting with the corresponding virtual desktop and/or application via an existing GUI-based remote desktop and/or application session, their actions may be collected. In some instances, these actions may be recorded for use in subsequent training of the LAM. In some instances, these actions may be recorded by the LAM server 504 itself (e.g., by monitoring the virtual desktop host server 503). Additionally or alternatively, these actions may be recorded by a LAM agent, executing at the virtual desktop host server 503, and then sent, by the LAM agent, to the LAM server 504.

For example, the end users may be requesting the performance of various actions with regard to the virtual desktop and/or application, such as send an email, provide a summary of unread emails, provide a summary of a particular number of emails sent by a particular sender, list titles of recently modified documents, summarize a document, request engineering specifications, summarize engineering specifications, create a document with a particular title, create a service ticket, request identification of orders delivered during a particular timeframe, request pending orders directed to a particular department, request tracking information for an order, and/or other actions. As these actions are requested, the LAM server 504 and/or LAM agent may redirect end-user inputs (such as keyboard keystrokes, mouse events, and/or other inputs) and any corresponding data to the database at the LAM server 504 (e.g., similar to session shadowing, but with end-user inputs being forwarded).

In some instances, this information may be sent in substantially real time. In other instances, the end-user sessions may be recorded and played back at a subsequent time, at which point the corresponding data may be collected. In some instances, this feature may be enhanced to also include all end-user inputs (keystrokes and mouse events, or the like) in the recording. In these instances, the recording may be used (in full or in part) for delayed training of the LAM (meaning that the session recording data may be used as training data for the LAM because it may contain all relevant information). In some instances, the user may indicate a starting point and/or ending point for the recording via a session recording feature, which may be targeted for training of a particular action.

In some instances, collection of this training data may be either implicit or explicit. In the explicit case, the end-user signals to the LAM agent when the training for a specific action (e.g., send an email to someone) starts and when it stops. For example, this may be performed via a UI element either in a published desktop itself (i.e., the LAM agent may display the UI upon the user's request—e.g., via the start menu), or the UI may be part of the remote desktop application itself (e.g., as an additional UI element). If the UI element is part of the remote desktop application, then the request to start/stop a training may be sent over a remote protocol virtual channel. In some instances, this UI element may also allow the end user to provide a textual description of the action that the LAM is being trained for (e.g., “send an email to someone”). In other instances, implicit training of the LAM may be applicable when a user or a group of users do repetitive identical complex actions with GUI-based published applications. This resulting training data may be sent, along with the textual description of the action, may be sent to storage associated with the LAM server 504.

At step 602, the LAM server 504 may train the LAM itself based on the training data received/collected at step 601. For example, the LAM server 504 may establish stored correlations between the training data and the corresponding textual description of the action, which may e.g., configure the LAM to identify, for a given action, what steps may be performed to accomplish the corresponding action. In some instances, the LAM server 504 may train the LAM on a user by user basis, client by client basis, or the like. In some instances, the training performed for one user may be applicable to other users. For example, a privileged user (administrator or other) may train the LAM for a specific action that may subsequently be distributed to other users/clients. In some instances, the LAM may be trained on repetitive actions, and therefore may be able to execute one of the actions upon request via the CUI/VUI in collaboration with the LAM agent.

In particular, in training the LAM, the LAM server 504 may learn how to execute an action by observing how it is performed by a user or group of users, meaning the LAM may later be able to do the tasks that may be needed to execute a requested action. For example, considering the tasks needed to execute the action of “send an email to someone,” the LAM may be able to learn these tasks from its training. For example, the LAM may be trained on what tasks to perform and the corresponding sequence, which may include, for example: 1) start email application (if not already started), select email application (if not already selected), click on new email icon, find email address of recipient from its name, input recipient email address, input the subject of the email, input the body of the email, ask for confirmation to send the composed email, and send the email by clicking on the send button. In some instances, this set of tasks may be labelled based on the corresponding action.

At step 603, once the LAM is trained, an agent including functionality of the LAM (e.g., the LAM agent) may be deployed from the LAM server 504 to the virtual desktop host server 503. In some instances, the virtual desktop host server 503 may be preconfigured with the LAM agent, but an update to the LAM agent may be deployed based on the LAM trained at step 602.

At step 604, the client device 502 may authenticate to the delivery server 506 (e.g., via the remote desktop client application). For example, the client device 502 may provide authentication credentials such as a user name, password, one time password information, push notification verification, and/or other credentials to delivery server 506. These authentication credentials may be validated by the delivery server 506, and an authentication token may be provided to the client device 502 in response, which may, e.g., be used to authenticate the client device 502 to the LAM server 504, LLM server 505, and/or delivery server 506.

At step 605, the client device 502 may request virtual desktops/applications available from the delivery server 506 and/or LAM server 504 (e.g., initiate desktop and application enumeration). In doing so, the client device 502 may receive a list of available desktops, applications, or the like, and lists of corresponding actions that may be performed by each (which may include, for each action, corresponding parameters). In some instances, the client device 502 may request these virtual desktops/applications from the LAM server 504, which may, in some instances, include passing the request through the delivery server 506 connected to both client device 502. For example, the delivery server 506 may interoperate with the LAM server 504 to obtain the list of possible actions and their parameters (which the LAM server 504 may be configured with due to the prior training of the LAM). In some instances, this request may be sent from the client device 502 via the client side remote desktop application.

At step 606, the LAM server 504 and/or delivery server 506 may identify the available desktops, application, or the like, and lists of corresponding actions that may be performed by each (which may include, for each action, corresponding parameters), and may send this list to the client device 502 (e.g., to the remote desktop client application). For example, the LAM server 504 may send the list through the delivery server 506 connected to both the client device 502 and the LAM server 504. In some instances, the LAM server 504 may update/further train the LAM based on this list. For example, the LAM may be trained based on the lists of actions for each application, where list may be labelled based on the corresponding application.

At step 607, the client device 502 may output the available desktops, applications, or the like within the remote desktop client application. In some instances, this may include providing a GUI that includes the available desktops, applications, or the like, and the corresponding tasks (or a portion thereof) that may be performed via these desktops/applications. In other instances, this may include providing an audio indication of the available desktops, applications, or the like (i.e., where a screen is unavailable at the client device 502 or it is otherwise impractical to display the GUI, such as where a screen of the client device 502 is too small for realistic viewing). In some instances, this may be an optional step, where the available desktops, applications, and corresponding actions are stored and/or otherwise made available to the client device 502, but might not be output at this time.

Referring to FIG. 6B, at step 608, the client device 502 may receive user input. In some instances, in receiving the user input the client device 502 may receive a voice input, a chatbot input, and/or other user input via the client side remote desktop application. For example, the client device 502 may receive a conversational voice request via a voice user interface (VUI), chat user interface (CUI), or the like requesting performance of a particular action.

At step 609, the client device 502 may communicate with the delivery server 506 to identify a desktop and/or application, and the corresponding action, that addresses the conversational voice request received at step 608. For example, the delivery server 506 may obtain this information from the LLM server 505, which may host a pre-trained LLM configured to perform speech synthesis. The LLM server 505 may generate a prompt for input into the LLM which includes the conversational voice request and a request to identify the relevant desktop/application and corresponding action. The LLM server 505 may identify the relevant desktop/application and corresponding action accordingly, and may output a response to the delivery server 506, which may provide the response to client device 502 accordingly. In some instances, these lists of applications and the corresponding actions may be stored at a database of the delivery server 506, which the delivery server 506 may access upon launch.

At step 610, the client device 502 may send a request to launch the desktop/application identified in the response at step 609. For example, the client device 502 may send the request to the virtual desktop host server 503. In some instances, in doing so, the client device 502 may send the request to the virtual desktop host server 503 via the delivery server 506. At step 611, the virtual desktop host server 503 may communicate with the client device 502 to launch the requested application/desktop.

At step 612, the client device 502 may connect the launched application/desktop to the virtual desktop host server 503. For example, the client device 502 may establish a remote desktop protocol connection (which may, e.g., be subdivided into multiple virtual channels) with the virtual desktop host server 503. For example, the delivery server 506 may broker a connection between the client device 502 and the virtual desktop host server 503.

In some instances, this remote desktop protocol connection may be bypassed due to a low amount of bandwidth needed by a LAM virtual channel (e.g., because all the exchanges may be textual, such as the name of an action to execute (e.g., send an email), its parameters (e.g., recipient, subject, or the like), and a textual description of the result of executing the action). Instead, a persistent websocket-based protocol may be used to communicate with a gateway service, which may, in turn, communicate with the virtual desktop host server 503. In these instances, the persistent websocket-based protocol connection may be established once the virtual desktop host server 503 loads up. In some instances, the client device 502 may authenticate to the virtual desktop host server 503 using the authentication token received during authentication at step 601. In some instances, this may include creating a session for a new user, or reconnecting an existing user's disconnected session. In some instances, where the virtual desktop host server 503 is a multi-session virtual desktop host server, the websocket connection may be multiplexed for the handling of multiple users sessions. On the virtual desktop host server 503 side, the websocket connection may be integrated within an existing virtual desktop application session manager to launch new sessions, manage disconnected sessions, or the like. Although illustrated at step 612, this websocket connection may, in some instances, be established prior to step 601 and used to facilitate communication between the client device 502 and the virtual desktop host server 503.

In some instances, a standard remote desktop protocol connection may be used to give the end-user the ability to issue high level declarative style requests via an additional VUI and/or CUI, observe, and use the results directly. Although illustrated at step 612, in some instances, this connection may be established at any time during the virtual desktop session. This may, for example, give the end-user the ability to use an existing/legacy GUI-based application with a VUI and/or CUI with high level declarative requests in the context of published virtual applications and/or desktops. In some instances, the high level relative declarative requests may be sent over the LAM virtual channel (VC), which may be a dedicated subchannel (among other VCs) within the remote desktop protocol. For example, use of this LAM VC may greatly simplify the remote desktop protocol (which in some CUI/VUI scenarios might not need to include any VC related to remoting a display from the virtual desktop host server 503) to the client device 502 (e.g., because the LAM VC is light weight, and uses little bandwidth because it is textual in nature).

At step 613, the virtual desktop host server 503 may identify an action (or multiple actions), to be executed within the launched virtual desktop and/or application, to address the user request received at step 608. For example, the virtual desktop host server 503 may input the request into the LAM configured within the LAM agent, which may, e.g., identify (based on the training performed at steps 601/602) the relevant actions. For example, the virtual desktop host server 503 may identify, using a stored correlation between the user request and a given action, the relevant action.

At step 614, the virtual desktop host server 503 may use the LAM agent to communicate with the LAM server 504 to execute steps to perform the identified actions. For example, as described above at step 602, the steps needed to execute a given action may be stored in the database of the LAM server 504. Accordingly, the virtual desktop host server 503 may communicate with the LAM server 504 using the LAM agent to identify these steps (e.g., by referencing a stored correlation between the overall action and the corresponding steps), and may cause execution of the steps accordingly.

For example, in the context of executing an action, the LAM server 504 (or LAM agent) may interact with an application's existing GUI, controlling mouse movements, generating mouse clicks, inputting text where appropriate by generating key strokes, or the like. All the previous interactions (including their precise order) may have been learned by the LAM during its training.

Referring to FIG. 6C, at step 615, the virtual desktop host server 503 may notify the client device 502 of the action, once complete. For example, the virtual desktop host server 503 may provide a visual indication (e.g., via a graphical user interface), an audio indication, and/or other indication that the action has been performed, results of the performance, and/or other information.

At step 616, the client device 502 may output the indication received at step 615. For example, the client device 502 may output a visual, audio, and/or other indication that the action has been performed, results of the performance, and/or other information. In some instances, the client device 502 may receive feedback from the user based on this indication. This feedback may, in some instances, be provided to the LAM server 504, which may, e.g., use the feedback to further train and/or otherwise refine the LAM and/or to update the LAM agent.

By operating in this way, the usage scenarios of a virtualization system may be increased by adding voice and/or chat interfaces to existing/legacy GUI-based virtualized applications and/or desktops. The VUI/CUI both may accept high level declarative style requests in a conversational way. Virtual applications/desktops may become usable with a range of new emerging devices, including devices only providing voice user interfaces (e.g., new wearable devices) by taking advantage of LLM and LAM capabilities. Furthermore, this may be a no-code solution.

More generally, this system may allow virtual applications and desktops to AI enable existing GUI-based applications and desktops by taking advantages of/reusing many aspects of these virtual applications and desktops themselves. In other words, this system may integrate fundamental elements of virtual applications and desktops with recent AI breakthroughs.

As is described further above, aspects of this system may include: 1) application enumeration data being sent to a client application that includes a list of actions (and associated parameters) that may be executed by the LAM agent with each application or desktop; 2) CUI/VUI use of a LLM to deduce which action the end-user may be requesting in a conversational way, and to retrieve the parameters of the actions and which desktop/application to use to execute the action; 3) introduction of a LAM virtual channel and lightweight remote desktop protocol when CUI/VUI is used; 4) a LAM agent running on a virtual desktop host system to execute actions, send back results, ask for confirmation over the LAM virtual channel, or the like; 5) session recording data being used as training data for the LAM; 6) the LAM agent being used for live LAM training; 7) an ability to bypass the standard remote desktop protocol and take advantage of an existing persistent websocket connection between the client and a gateway; and 8) the ability to add a voice or chat user interface to an existing virtualized GUI application or desktop with a no code and transparent approach.

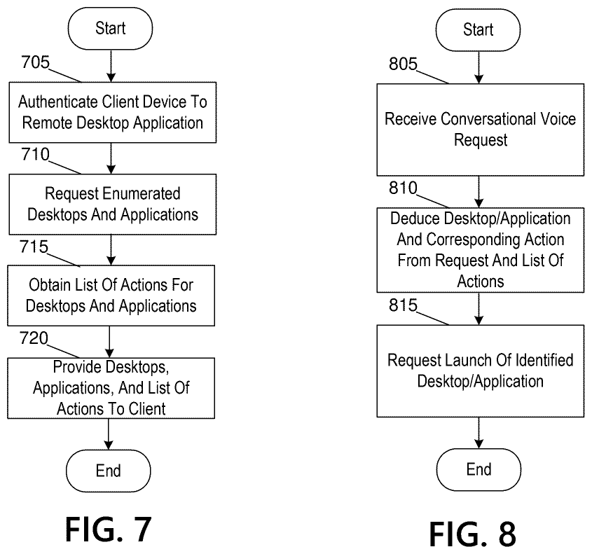

FIG. 7 depicts an illustrative method for using a large action model to facilitate voice and/or chat interfaces in GUI based virtualized applications and desktops in accordance with one or more example embodiments. Referring to FIG. 7, at step 705, a computing system comprising a memory and one or more processors may authenticate a client device. At step 710, the computing system may request enumerated virtual desktops and applications for the client. At step 715, the computing system may obtain a list of actions for the identified virtual desktops and applications. At step 720, the computing system may provide the identified virtual desktops, applications, and corresponding list of actions to the client.

FIG. 8 depicts an illustrative method for using a large action model to facilitate voice and/or chat interfaces in GUI based virtualized applications and desktops in accordance with one or more example embodiments. Referring to FIG. 8, at step 805, a computing system comprising a memory and one or more processors may receive a conversational voice request. At step 810, the computing system may deduce a virtual desktop/application, and a corresponding list of actions for the deduced desktop/application, which may be used to perform an action requested in the voice request. At step 815, the computing system may request launch of the identified virtual desktop/application.

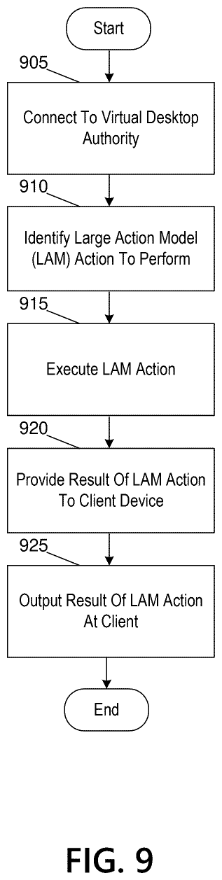

FIG. 9 depicts an illustrative method for using a large action model to facilitate voice and/or chat interfaces in GUI based virtualized applications and desktops in accordance with one or more example embodiments. Referring to FIG. 9, at step 905, a computing system comprising a memory and one or more processors may connect to a virtual desktop authority. At step 910, the computing system may identify a large action model action to perform. At step 915, the computing system may execute the LAM action. At step 920, the computing system may provide the result of the LAM action to a client device. At step 925, the computing system may cause output the result of the LAM at the client device.

In some instances, the methods illustrated in FIGS. 7-9 may be performed in sequence, or may be performed in a different order without departing from the scope of the disclosure.

The following paragraphs (M1) through (M10) describe examples of methods that may be implemented in accordance with the present disclosure.

(M1) A method comprising: training, using historical remote desktop interaction information indicating user inputs and corresponding actions executed within historical remote desktop application sessions, a large action model (LAM), wherein training the LAM configures the LAM to execute, for a given textual input, one or more actions to perform within a given remote desktop application to complete a task requested by the given textual input; deploying, to a remote desktop host server, a LAM agent, configured to access the LAM to identify the one or more actions; receiving, during a remote desktop session, a textual input indicating a first task to perform; identifying, based on the first task, a remote desktop application configured to perform the task and a list of actions that the remote desktop application is configured to perform; identifying, using a large language model (LLM), at least one action of the list of actions to execute to perform the task; executing, using the LAM, the at least one action to produce an action result; and displaying the action result, wherein the action result comprises an indication that the task has been executed.

(M2) A method may be performed as described in paragraph (M1) wherein training the LAM is further based on lists of actions corresponding to each remote desktop application of a plurality of remote desktop applications, wherein each list of actions is labelled based on the corresponding remote desktop application.

(M3) A method may be performed as described in any of paragraphs (M1) through (M2) further comprising establishing, based on successful validation of authentication credentials provided at a client device, the remote desktop session, wherein establishing the remote desktop session comprises receiving, at the client device and from the remote desktop host server, an authentication token

(M4) A method may be performed as described in paragraph (M3) wherein establishing the remote desktop session further comprises: identifying one or more applications corresponding to the remote desktop session and, for each of the one or more applications, a list of actions that the corresponding application is configured to performed.

(M5) A method may be performed as described in any of paragraphs (M1) through (M4) wherein identifying the remote desktop application comprises applying a large language model to the textual input to identify the remote desktop application.

(M6) A method may be performed as described in any of paragraphs (M1) through (M5) further comprising: launching, after identifying the remote desktop application, before identifying the at least one action, and via communication with the remote desktop host server, the remote desktop application.

(M7) A method may be performed as described in paragraph (M6) further comprising: after launching the remote desktop application and prior to the identification of the at least one action, establishing a connection between a client device and the remote desktop host server.

(M8) A method may be performed as described in paragraph (M7) wherein the connection comprises a remote desktop protocol connection, a websocket connection, or a LAM virtual channel (VC).

(M9) A method may be performed as described in any of paragraphs (M1) through (M8) further comprising: collecting feedback on the action result; and updating, based on the feedback, the LAM agent.

(M10) A method may be performed as described in paragraph (M7), wherein the client device comprises one of: smart glasses or a mobile device.

The following paragraphs (A1) through (A9) describe examples of apparatuses that may be implemented in accordance with the present disclosure.

(A1) A computing system may train, using historical remote desktop interaction information indicating user inputs and corresponding actions executed within historical remote desktop application sessions, a large action model (LAM), wherein training the LAM configures the LAM to execute, for a given textual input, one or more actions to perform within a given remote desktop application to complete a task requested by the given textual input; deploy, to a remote desktop host server, a LAM agent, configured to access the LAM to identify the one or more actions; receive, during a remote desktop session, a textual input indicating a first task to perform; identify, based on the first task, a remote desktop application configured to perform the task and a list of actions that the remote desktop application is configured to perform; identify, using a large language model (LLM), at least one action of the list of actions to execute to perform the task; execute, using the LAM, the at least one action to produce an action result; and display the action result, wherein the action result comprises an indication that the task has been executed

(A2) A computing system according to paragraph (A1), wherein training the LAM is further based on lists of actions corresponding to each remote desktop application of a plurality of remote desktop applications, wherein each list of actions is labelled based on the corresponding remote desktop application.

(A3) A computing system according to any of paragraphs (A1) through (A2), wherein the memory stores additional computer executable instructions that, when executed by the one or more processors, further cause the computing system to: establish, based on successful validation of authentication credentials provided at a client device, the remote desktop session, wherein establishing the remote desktop session comprises receiving, at the client device and from the remote desktop host server, an authentication token.

(A4) A computing system according to paragraph (A3) wherein establishing the remote desktop session further comprises: identifying one or more applications corresponding to the remote desktop session and, for each of the one or more applications, a list of actions that the corresponding application is configured to performed.

(A5) A computing system according to any of paragraphs (A1) through (A4) wherein identifying the remote desktop application comprises applying a large language model to the textual input to identify the remote desktop application.

(A6) A computing system according to any of paragraphs (A1) through (A5) wherein the memory stores additional computer executable instructions that, when executed by the one or more processors, further cause the computing system to: launch, after identifying the remote desktop application, before identifying the at least one action, and via communication with the remote desktop host server, the remote desktop application.

(A7) A computing system according to paragraph (A6) wherein the memory stores additional computer executable instructions that, when executed by the one or more processors, further cause the computing system to: after launching the remote desktop application and prior to the identification of the at least one action, establish a connection between a client device and the remote desktop host server.

(A8) A computing system according to paragraph (A7) wherein the connection comprises a remote desktop protocol connection or a websocket connection.

(A9) A computing system according to any of paragraphs (A1) through (A8) wherein the memory stores additional computer executable instructions that, when executed by the one or more processors, further cause the computing system to: collect feedback on the action result; and update, based on the feedback, the LAM agent.

The following paragraph (CRM1) through (CRMXX) describe examples of computer-readable media that may be implemented in accordance with the present disclosure.

(CRM1) A non-transitory computer-readable medium storing instructions that, when executed, cause a system to perform: training, using historical remote desktop interaction information indicating user inputs and corresponding actions executed within historical remote desktop application sessions, a large action model (LAM), wherein training the LAM configures the LAM to execute, for a given textual input, one or more actions to perform within a given remote desktop application to complete a task requested by the given textual input; deploying, to a remote desktop host server, a LAM agent, configured to access the LAM to identify the one or more actions; receiving, during a remote desktop session, a textual input indicating a first task to perform; identifying, based on the first task, a remote desktop application configured to perform the task and a list of actions that the remote desktop application is configured to perform; identifying, using a large language model (LLM), at least one action of the list of actions to execute to perform the task; executing, using the LAM, the at least one action to produce an action result; and displaying the action result, wherein the action result comprises an indication that the task has been executed.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
training, using historical remote desktop interaction information indicating user inputs and corresponding actions executed within historical remote desktop application sessions, a large action model (LAM), wherein training the LAM configures the LAM to execute, for a given textual input, one or more actions to perform within a given remote desktop application to complete a task requested by the given textual input;
deploying, to a remote desktop host server, a LAM agent, configured to access the LAM to identify the one or more actions;
receiving, during a remote desktop session, a textual input indicating a first task to perform;
identifying, based on the first task, a remote desktop application configured to perform the task and a list of actions that the remote desktop application is configured to perform;
identifying, using a large language model (LLM), at least one action of the list of actions to execute to perform the task;
executing, using the LAM, the at least one action to produce an action result; and
displaying the action result, wherein the action result comprises an indication that the task has been executed.

2. The method of claim 1, wherein training the LAM is further based on lists of actions corresponding to each remote desktop application of a plurality of remote desktop applications, wherein each list of actions is labelled based on the corresponding remote desktop application.

3. The method of claim 1, further comprising:
establishing, based on successful validation of authentication credentials provided at a client device, the remote desktop session, wherein establishing the remote desktop session comprises receiving, at the client device and from the remote desktop host server, an authentication token.

4. The method of claim 3, wherein establishing the remote desktop session further comprises:
identifying one or more applications corresponding to the remote desktop session and, for each of the one or more applications, a list of actions that the corresponding application is configured to performed.

5. The method of claim 1, wherein identifying the remote desktop application comprises applying a large language model to the textual input to identify the remote desktop application.

6. The method of claim 1, further comprising:
launching, after identifying the remote desktop application, before identifying the at least one action, and via communication with the remote desktop host server, the remote desktop application.

7. The method of claim 6, further comprising:
after launching the remote desktop application and prior to the identification of the at least one action, establishing a connection between a client device and the remote desktop host server.

8. The method of claim 7, wherein the connection comprises a remote desktop protocol connection, a websocket connection, or a LAM virtual channel (VC).

9. The method of claim 1, further comprising:
collecting feedback on the action result; and
updating, based on the feedback, the LAM agent.

10. The method of claim 7, wherein the client device comprises one of: smart glasses or a mobile device.

11. A computing system comprising:
one or more processors;
memory storing computer executable instructions that, when executed by the one or more processors, cause the computing system to:
train, using historical remote desktop interaction information indicating user inputs and corresponding actions executed within historical remote desktop application sessions, a large action model (LAM), wherein training the LAM configures the LAM to execute, for a given textual input, one or more actions to perform within a given remote desktop application to complete a task requested by the given textual input;
deploy, to a remote desktop host server, a LAM agent, configured to access the LAM to identify the one or more actions;
receive, during a remote desktop session, a textual input indicating a first task to perform;
identify, based on the first task, a remote desktop application configured to perform the task and a list of actions that the remote desktop application is configured to perform;
identify, using a large language model (LLM), at least one action of the list of actions to execute to perform the task;
execute, using the LAM, the at least one action to produce an action result; and
display the action result, wherein the action result comprises an indication that the task has been executed.

12. The computing system of claim 11, wherein training the LAM is further based on lists of actions corresponding to each remote desktop application of a plurality of remote desktop applications, wherein each list of actions is labelled based on the corresponding remote desktop application.

13. The computing system of claim 11, wherein the memory stores additional computer executable instructions that, when executed by the one or more processors, further cause the computing system to:
establish, based on successful validation of authentication credentials provided at a client device, the remote desktop session, wherein establishing the remote desktop session comprises receiving, at the client device and from the remote desktop host server, an authentication token.

14. The computing system of claim 13, wherein establishing the remote desktop session further comprises:
identifying one or more applications corresponding to the remote desktop session and, for each of the one or more applications, a list of actions that the corresponding application is configured to performed.

15. The computing system of claim 11, wherein identifying the remote desktop application comprises applying a large language model to the textual input to identify the remote desktop application.

16. The computing system of claim 11, wherein the memory stores additional computer executable instructions that, when executed by the one or more processors, further cause the computing system to:
launch, after identifying the remote desktop application, before identifying the at least one action, and via communication with the remote desktop host server, the remote desktop application.

17. The computing system of claim 16, wherein the memory stores additional computer executable instructions that, when executed by the one or more processors, further cause the computing system to:
after launching the remote desktop application and prior to the identification of the at least one action, establish a connection between a client device and the remote desktop host server.

18. The computing system of claim 17, wherein the connection comprises a remote desktop protocol connection or a websocket connection.

19. The computing system of claim 11, wherein the memory stores additional computer executable instructions that, when executed by the one or more processors, further cause the computing system to:
collect feedback on the action result; and
update, based on the feedback, the LAM agent.

20. One or more non-transitory computer-readable media storing instructions that, when executed by a computing system comprising at least one processor, a communication interface, and memory, cause the computing system to:
train, using historical remote desktop interaction information indicating user inputs and corresponding actions executed within historical remote desktop application sessions, a large action model (LAM), wherein training the LAM configures the LAM to execute, for a given textual input, one or more actions to perform within a given remote desktop application to complete a task requested by the given textual input;
deploy, to a remote desktop host server, a LAM agent, configured to access the LAM to identify the one or more actions;
receive, during a remote desktop session, a textual input indicating a first task to perform;
identify, based on the first task, a remote desktop application configured to perform the task and a list of actions that the remote desktop application is configured to perform;
identify, using a large language model (LLM), at least one action of the list of actions to execute to perform the task;
execute, using the LAM, the at least one action to produce an action result; and
display the action result, wherein the action result comprises an indication that the task has been executed.
